(19) United States
(12) Patent Application Publication
(10) Pub. No.: US 2008/0019860 A1
(43) Pub. Date: Jan. 24, 2008

(54) LIQUID MONOPHASIC LIPID-SOLUBLE ANTIOXIDANT COMPOSITIONS AND PROCESSES FOR MAKING THE COMPOSITIONS

(75) Inventors: Ibrahim Abou-Nemeh, Lake St. Louis, MO (US); Prakash Wadhwa, Overland, KS (US)

Correspondence Address: POLSINELLI SHALTON FLANIGAN SUELTHAUS PC, 700 W. 47TH STREET, SUITE 1000, KANSAS CITY, MO, 64112-1802, US

(73) Assignee: NOVUS INTERNATIONAL INC., St. Louis, MO (US)

(21) Appl. No.: 11/773,093

(22) Filed: Jul. 3, 2007

Related U.S. Application Data
(60) Provisional application No. 60/807,980, filed on Jul. 21, 2006.

(51) Int. Cl. C09K 15/08; C11B 5/00

(52) U.S. Cl. 422/1; 252/404; 252/405

(57) ABSTRACT

The invention provides liquid monophasic antioxidant compositions that are miscible in a lipid material. The monophasic antioxidant compositions may be added to a lipid material to prevent their oxidation. The invention also provides a process for the preparation of the antioxidant compositions.

### CROSS-REFERENCE TO RELATED APPLICATIONS

This application claims priority to U.S. Provisional Application Ser. No. 60/807,980 filed on Jul. 21, 2006, which is hereby incorporated by reference in its entirety.

### FIELD OF THE INVENTION

The invention generally provides antioxidants formulated as liquid monophasic lipid-soluble compositions. The invention also provides processes for making the compositions.

### BACKGROUND OF THE INVENTION

Vegetable oils and animal fats provide 2.5 times the energy as carbohydrate or protein, and thus, are efficient high energy feed supplements. Oils and fats contain mostly triglycerides, which are glycerol esters of mid to long chain fatty acids. All oils and fats are prone to oxidation, a degradation process that reduces the nutritional value and produces volatile compounds having unpleasant smells and tastes (i.e., rancidity). During lipid oxidation a free radical is formed by the removal of a labile hydrogen atom from a carbon atom adjacent to a double bond. The resultant free radical is susceptible to attack by oxygen to form a free radical peroxide, which then serves as a catalyst of further oxidation. Thus, the oxidative breakdown of lipids is autocatalytic, giving rise to a chain reaction and the formation of undesirable breakdown products (e.g., ketones, aldehydes, alcohols, acids, etc). The rate of oxidation increases with the degree of unsaturation. Fish and vegetable oils are enriched in polyunsaturated fatty acids (PUFA), and in particular, omega-3 fatty acids. Fish oils contain eicosapentaenoic acid (EPA) and docosohexaenoic acid (DHA), which contain five and six double bonds, respectively, and some vegetable oils contain alpha-linolenic acid (ALA), which has three double bonds.

Antioxidants are chemicals that inhibit lipid oxidation. Some antioxidants (e.g., phenolic compounds) interrupt the free-radical chain of oxidative reactions by complexing with free radicals to form stable compounds that do not initiate or propagate further oxidation. Other antioxidants (e.g., acid compounds) slow the oxidative process by scavenging the reactive oxygen species. And still other antioxidants (e.g., chelators) slow oxidation by complexing with pro-oxidative metal ions. Various antioxidant compositions have been developed for the stabilization of oils and fats; most are mixtures of natural phenolic compounds (e.g., tocopherols) and acid compounds (e.g., ascorbic acid). While these antioxidant compositions inhibit lipid oxidation, they are not nearly as effective as synthetic phenolic antioxidants. One of the most effective antioxidants is ethoxyquin (6-ethoxy-1,2-dihydro-2,2,4-trimethylquinoline, sold under the trademark SANTOQUIN®), which is widely used as an antioxidant or preservative in feed supplements and a variety of other applications. Regulations in a variety of countries, however, have reduced the maximum allowable level of ethoxyquin in the final food product (e.g., meat or fish) such that the currently used levels of ethoxyquin must be reduced. In some instances, the required reduction is about 10-fold. Consequently, new antioxidant formulations with lower levels of ethoxyquin are needed. Furthermore, lipid-soluble formulations that can be added directly to fish oils, vegetable oils, or animal fats are needed.

### SUMMARY OF THE INVENTION

One aspect of the invention provides liquid monophasic lipid-soluble antioxidant compositions. In one embodiment, the antioxidant composition comprises at least three antioxidants consisting of a first antioxidant that is a synthetic phenolic compound not having Formula (I), a second antioxidant selected from the group consisting of phenolic acid and derivatives, ascorbic acid and derivatives, tocopherols and derivatives, lecithin, bioflavonoid, and terpenoid; and a third antioxidant having Formula (I) as described further herein. The antioxidant composition also comprises a polar solvent; and a nonpolar solvent that are selected such that the two solvents form a substantially homogenous liquid.

An alternative aspect of the invention encompasses a monophasic lipid-soluble antioxidant composition. The composition comprises 6-ethoxy-1,2-dihydro-2,2,4-trimethylquinoline, tertiary butyl hydroquinone, lecithin, n-propyl gallate, a polar solvent, and a non-polar solvent. The two solvents are selected so that they form a substantially homogenous liquid.

Yet another aspect of the invention provides a method for inhibiting the oxidation of a lipid material. The method comprises contacting the lipid material with an effective amount of a monophasic antioxidant composition of the invention.

An additional aspect of the invention provides a composition comprising a product derived from a fish; and a monophasic antioxidant composition of the invention.

A further aspect of the invention provides a process for manufacturing a monophasic antioxidant composition. The process comprises heating a vegetable oil to a temperature from about 40° C. to about 90° C., combining the vegetable oil with monoglycerides, and then combining the vegetable oil with 6-ethoxy-1,2-dihydro-2,2,4-trimethylquinoline while maintaining the temperature and agitating to form a 6-ethoxy-1,2-dihydro-2,2,4-trimethylquinoline-oil matrix. The matrix is then sequentially combined first with tertiary butyl hydroquinone followed by lecithin while maintaining the temperature and agitating, such that the lecithin is dissolved in the oil matrix. Propyl gallate is dissolved in a solvent selected from the group consisting of glycerin and propylene glycol, and then this product is combined with the matrix product while maintaining the agitation and temperature for a time sufficient such that a substantially homogeneous liquid is produced. During the entire process, typically nitrogen blanking is utilized during the addition of reactants to minimize oxidation during the preparation process.

### DESCRIPTION OF THE DRAWINGS

FIG. 1 is a bar graph illustrating the Oxidative Stability Index (OSI) value of menhaden oil alone or in the presence of various antioxidants or antioxidant formulations. The antioxidants were ethoxyquin (EQ), tertiary butyl hydroquinone (TBHQ), n-propyl gallate (PG), ascorbyl palmitate (AP), and lecithin (LE). The formulations were #9: EQ+TBHQ; #11: EQ+TBHQ+AP; #15: EQ+TBHQ+AP+PG; #16: EQ+TBHQ+AP+PG+NMT; #27: EQ+TBHQ+AP+LE; #29: EQ+TBHQ+PG+LE; and #32: EQ+TBHQ+AP+PG+NMT+LE.

FIG. 2 is a bar graph illustrating the Oxidative Stability Index (OSI) value of anchovy oil alone or in the presence of various antioxidants or antioxidant formulations. The antioxidants were ethoxyquin (EQ), tertiary butyl hydroquinone (TBHQ), n-propyl gallate (PG), ascorbyl palmitate (AP), and lecithin (LE). The formulations were #9: EQ+TBHQ; #11: EQ+TBHQ+AP; #15: EQ+TBHQ+AP+PG; #16: EQ+TBHQ+AP+PG+NMT; #27: EQ+TBHQ+AP+LE; #29: EQ+TBHQ+PG+LE; and #32: EQ+TBHQ+AP+PG+NMT+LE.

FIG. 3 is a bar graph illustrating the Oxidative Stability Index (OSI) value of soybean oil alone or in the presence of various antioxidant formulations. The antioxidants were ethoxyquin (EQ), tertiary butyl hydroquinone (TBHQ), n-propyl gallate (PG), ascorbyl palmitate (AP), and lecithin (LE). The formulations were #9: EQ+TBHQ; #11: EQ+TBHQ+AP; #15: EQ+TBHQ+AP+PG; #16: EQ+TBHQ+AP+PG+NMT; #27: EQ+TBHQ+AP+LE; #29: EQ+TBHQ+PG+LE; and #32: EQ+TBHQ+AP+PG+NMT+LE.

FIG. 4 is a bar graph illustrating the Oxidative Stability Index (OSI) value of poultry fat alone or in the presence of various antioxidant formulations. The antioxidants were ethoxyquin (EQ), tertiary butyl hydroquinone (TBHQ), n-propyl gallate (PG), ascorbyl palmitate (AP), and lecithin (LE). The formulations were #9: EQ+TBHQ; #11: EQ+TBHQ+AP; #15: EQ+TBHQ+AP+PG; #16: EQ+TBHQ+AP+PG+NMT; #27: EQ+TBHQ+AP+LE; #29: EQ+TBHQ+PG+LE; and #32: EQ+TBHQ+AP+PG+NMT+LE.

FIG. 5 is a bar graph illustrating the Oxidative Stability Index (OSI) value of biodiesel alone or in the presence of various antioxidant formulations. The antioxidants were ethoxyquin (EQ), tertiary butyl hydroquinone (TBHQ), n-propyl gallate (PG), ascorbyl palmitate (AP), and lecithin (LE). The formulations were #9: EQ+TBHQ; #11: EQ+TBHQ+AP; #15: EQ+TBHQ+AP+PG; #16: EQ+TBHQ+AP+PG+NMT; #27: EQ+TBHQ+AP+LE; #29: EQ+TBHQ+PG+LE; and #32: EQ+TBHQ+AP+PG+NMT+LE.

FIG. 6 presents photoimages of tubes of an antioxidant formulation containing different amounts of polar and nonpolar solvents. The formulation was #32: EQ+TBHQ+AP+PG+NMT+LE. Panel A shows the formulation made with corn oil. Panel B shows the formulation made with corn oil and propylene glycol. Panel C shows the formulation made with corn oil and glycerol. Panel D shows the formulation made with corn oil, monoglycerides, and propylene glycol. Panel E shows the formulation made with corn oil, monoglycerides, and glycerol. All of the tubes were centrifuges at 3,600 rpm for 15 minutes.

FIG. 7 is a graph of the percent moisture in different fishmeal samples over 24 weeks. The solid line represents the negative control (untreated) sample. Also presented are samples treated with a high concentration of ethoxyquin at 735 ppm (SQ-725), the B-29 antioxidant formulation at 925 ppm (B29-925), and the B-29 antioxidant formulation at 1789 ppm (B29-1789).

FIG. 8 is a graph presenting the peroxide values (IPV) of the different fishmeal samples over 24 weeks. The solid line represents the negative control (untreated) sample. Also presented are samples treated with a high concentration of ethoxyquin at 735 ppm (SQ-725), the B-29 antioxidant formulation at 925 ppm (B29-925), and the B-29 antioxidant formulation at 1789 ppm (B29-1789).

FIG. 9 is a graph presenting the percentage of fat in the different fishmeal samples over 24 weeks. The percentage of fat was determined using a petroleum ether extraction technique. The solid line represents the negative control (untreated) sample. Also presented are samples treated with a high concentration of ethoxyquin at 735 ppm (SQ-725), the B-29 antioxidant formulation at 925 ppm (B29-925), and the B-29 antioxidant formulation at 1789 ppm (B29-1789).

FIG. 10 is a graph presenting the percentage of fat in the different fishmeal samples over 24 weeks. The percentage of fat was determined using the Bligh & Dyer chloroform extraction technique. The solid line represents the negative control (untreated) sample. Also presented are samples treated with a high concentration of ethoxyquin at 735 ppm (SQ-725), the B-29 antioxidant formulation at 925 ppm (B29-925), and the B-29 antioxidant formulation at 1789 ppm (B29-1789).

FIG. 11 is a graph presenting the iodine values of the different fishmeal samples over 24 weeks. The solid line represents the negative control (untreated) sample. Also presented are samples treated with a high concentration of ethoxyquin at 735 ppm (SQ-725), the B-29 antioxidant formulation at 925 ppm (B29-925), and the B-29 antioxidant formulation at 1789 ppm (B29-1789).

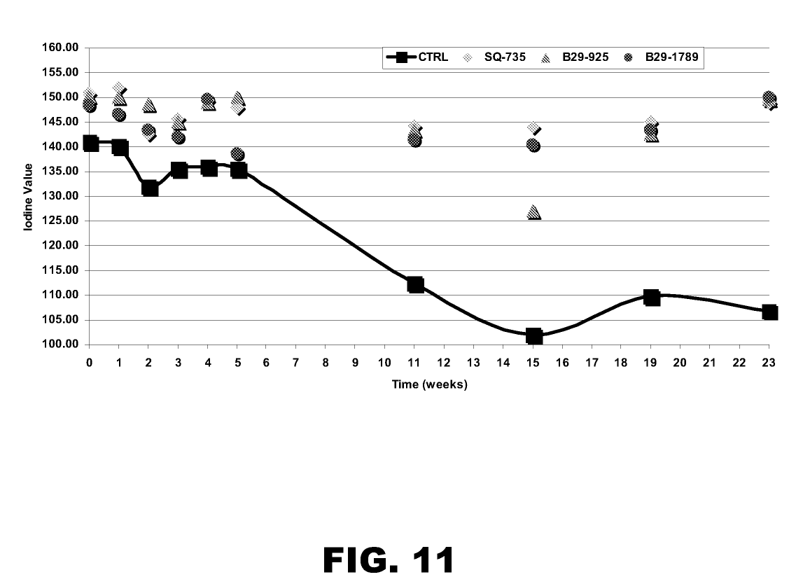

### DETAILED DESCRIPTION OF THE PREFERRED EMBODIMENTS

The present invention provides liquid monophasic combinations of antioxidant compositions that are miscible in a lipid material. Advantageously, as illustrated in the examples, the antioxidants utilized in the monophasic compositions, when combined together, protect the lipid material from oxidation longer then the summed protection provided by each of the antioxidants used alone. Moreover, the antioxidant combinations, as illustrated in the examples, protect the lipid material from oxidation for times similar to formulations containing ethoxyquin alone.

(I) Monophasic Antioxidant Compositions

The monophasic antioxidant compositions of the invention generally comprise a combination of antioxidants and a solvent comprising a polar solvent and a non-polar solvent. Suitable antioxidants and solvents are detailed below. Processes for making the monophasic antioxidant compositions are detailed in the examples.

(a) Antioxidants

Several antioxidants are suitable for use in the invention. The antioxidant may be a compound that interrupts the free-radical chain of oxidative reactions by protonating free radicals, thereby inactivating them. The antioxidant may be a compound that scavenges the reactive oxygen species. Alternatively, the antioxidant may be a compound that chelates the metal catalysts. The antioxidant may be a synthetic compound, a semi-synthetic compound, or a natural (or naturally-derived) compound.

The antioxidant composition typically includes an antioxidant that is a substituted 1,2-dihydroquinoline. Substituted 1,2-dihydroquinoline compounds suitable for use in the invention generally correspond to Formula (I):

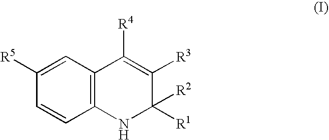

wherein:
R¹, R², R³ and R⁴ are independently selected from the group consisting of hydrogen and an alkyl group having from 1 to about 6 carbons; and
R⁵ is an alkoxy group having from 1 to about 12 carbons.

In another embodiment, the substituted 1,2-dihydroquinoline will have Formula (I)

wherein:
R¹, R², R³ and R⁴ are independently selected from the group consisting of hydrogen and an alkyl group having from 1 to about 4 carbons; and
R⁵ is an alkoxy group having from 1 to about 4 carbons.

In a preferred embodiment, the substituted 1,2-dihydroquinoline will be 6-ethoxy-1,2-dihydro-2,2,4-trimethylquinoline having the structure:

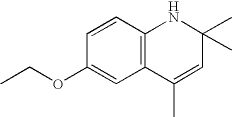

The compound, 6-ethoxy-1,2-dihydro-2,2,4-trimethylquinoline, commonly known as ethoxyquin, is sold under the trademark SANTOQUIN®. The present invention also encompasses salts of ethoxyquin and other compounds having Formula (I). Ethoxyquin and other compounds having Formula (I) may be purchased commercially from Novus International, Inc. or made in accordance with methods generally known in the art, for example, as detailed in U.S. Pat. No. 4,772,710, which is hereby incorporated by reference in its entirety.

As will be appreciated by a skilled artisan, the concentration of compounds having formula (I) in the monophasic compositions of the invention can and will vary depending on the intended use of the application. By way of example, the concentration of the substituted 1,2-dihydroquinoline in the monophasic antioxidant composition may range from 5 ppm to about 1000 ppm. In other embodiments, the concentration may range from about 50 to about 500 ppm. In still additional embodiments, the concentration may range from about 50 to about 200 ppm. In a preferred embodiment, the concentration of 6-ethoxy-1,2-dihydro-2,2,4-trimethylquinoline (ethoxyquin) may be about 100 ppm.

The amount of the antioxidant having Formula (I) may also be expressed in percent of the antioxidant composition by weight. In one embodiment, the amount of the substituted 1,2-dihydroquinoline in the monophasic antioxidant may range from about 0.0001% to about 20% by weight. In another embodiment, the amount may range from about of 1% to about 15% by weight. In yet another embodiment, the amount may range from 3.75% to about 10% by weight. In a preferred embodiment, the amount of 6-ethoxy-1,2-dihydro-2,2,4-trimethylquinoline (ethoxyquin) may be about 5% by weight, less than about 5% by weight, less than about 4% by weight, less than about 3% by weight, less than about 2% by weight, or less than about 1% by weight.

The antioxidant composition further includes antioxidants not having Formula (I). Suitable antioxidants include, but are not limited to, ascorbic acid and its salts, ascorbyl palmitate, ascorbyl stearate, anoxomer, N-acetylcysteine, benzyl isothiocyanate, o-, m- or p-amino benzoic acid (o is anthranilic acid, p is PABA), butylated hydroxyanisole (BHA), butylated hydroxytoluene (BHT), caffeic acid, canthaxantin, alpha-carotene, beta-carotene, beta-caraotene, beta-apo-carotenoic acid, carnosol, carvacrol, catechins, cetyl gallate, chlorogenic acid, citric acid and its salts, clove extract, coffee bean extract, p-coumaric acid, 3,4-dihydroxybenzoic acid, N,N′-diphenyl-p-phenylenediamine (DPPD), dilauryl thiodipropionate, distearyl thiodipropionate, 2,6-di-tert-butylphenol, dodecyl gallate, edetic acid, ellagic acid, erythorbic acid, sodium erythorbate, esculetin, esculin, 6-ethoxy-1,2-dihydro-2,2,4-trimethylquinoline, ethyl gallate, ethyl maltol, ethylenediaminetetraacetic acid (EDTA), eucalyptus extract, eugenol, ferulic acid, flavonoids, flavones (e.g., apigenin, chrysin, luteolin), flavonols (e.g., datiscetin, myricetin, daemfero), flavanones, fraxetin, fumaric acid, gallic acid, gentian extract, gluconic acid, glycine, gum guaiacum, hesperetin, alpha-hydroxybenzyl phosphinic acid, hydroxycinammic acid, hydroxyglutaric acid, hydroquinone, N-hydroxysuccinic acid, hydroxytryrosol, hydroxyurea, ice bran extract, lactic acid and its salts, lecithin, lecithin citrate; R-alpha-lipoic acid, lutein, lycopene, malic acid, maltol, 5-methoxy tryptamine, methyl gallate, monoglyceride citrate; monoisopropyl citrate; morin, beta-naphthoflavone, nordihydroguaiaretic acid (NDGA), octyl gallate, oxalic acid, palmityl citrate, phenothiazine, phosphatidylcholine, phosphoric acid, phosphates, phytic acid, phytylubichromel, pimento extract, propyl gallate, polyphosphates, quercetin, trans-resveratrol, rosemary extract, rosmarinic acid, sage extract, sesamol, silymarin, sinapic acid, succinic acid, stearyl citrate, syringic acid, tartaric acid, thymol, tocopherols (i.e., alpha-, beta-, gamma- and delta-tocopherol), tocotrienols (i.e., alpha-, beta-, gamma- and delta-tocotrienols), tyrosol, vanilic acid, 2,6-di-tert-butyl-4-hydroxymethylphenol (i.e., lonox 100), 2,4-(tris-3′,5′-bi-tert-butyl-4′-hydroxybenzyl)-mesitylene (i.e., lonox 330), 2,4,5-trihydroxybutyrophenone, ubiquinone, tertiary butyl hydroquinone (TBHQ), thiodipropionic acid, trihydroxy butyrophenone, tryptamine, tyramine, uric acid, vitamin K and derivates, vitamin Q10, wheat germ oil, zeaxanthin, or combinations thereof.

Exemplary antioxidants not having formula (I) include synthetic phenolic compounds, such as tertiary butyl hydroquinone (TBHQ); gallic acid derivatives, such as n-propyl gallate; vitamin C derivatives, such as ascorbyl palmitate; lecithin; and vitamin E compounds, such as, alpha-tocopherol. In one embodiment, the second antioxidant may be TBHQ.

The concentration of the antioxidants not having formula (I) will vary depending upon the total number of antioxidants. By way of non-limiting example, the concentration of TBHQ in the antioxidant composition may range from about 50 ppm to about 300 ppm (or from about 2.5% to about 20% by weight). The concentration of n-propyl gallate may range from about 50 ppm to about 300 ppm (or from about 2.5% to about 20% by weight). The concentration of ascorbyl palmitate may range from about 50 ppm to about 300 ppm (or from about 2.5% to about 20% by weight). The concentration of lecithin may range from about 50 ppm to about 300 ppm (or from about 2.5% to about 20% by weight). The concentration of alpha-tocopherol may range from about 100 ppm to about 400 ppm (or from about 3.75% to about 30% by weight). Thus, the total concentration of antioxidant may range from about 50 ppm to about 2000 ppm. In preferred embodiments, the concentration of TBHQ may be 200 ppm, the concentration of n-propyl gallate may be 200 ppm, the concentration of ascorbyl palmitate may be 200 ppm, the concentration of lecithin may be 200 ppm, and the concentration of alpha-tocopherol may be 300 ppm.

(b) Formulations of Antioxidant Combinations

Suitable antioxidant combinations for use in the present invention include at least one of the substituted dihydroquinoline compounds having formula (I), and a synthetic phenolic compound not having formula (I). In an exemplary embodiment, the combination will also include at least one compound selected from the group consisting of phenolic acid and derivatives, ascorbic acid and derivatives, tocopherols and derivatives, lecithin, bioflavonoid, and terpenoid. In some embodiments, the combination may include at least three different antioxidants. In additional embodiments, the combination may include four or more different antioxidants. Non-limiting examples of suitable antioxidant combinations are set-forth in Table A (i.e., the first antioxidant in column one is combined with the second antioxidant in column two to form an antioxidant combination of the invention). A preferred composition comprises 6-ethoxy-1,2-dihydro-2,2,4-trimethylquinoline (ethoxyquin) and tertiary butyl hydroquinone. Other preferred compositions comprise 6-ethoxy-1,2-dihydro-2,2,4-trimethylquinoline (ethoxyquin) and tertiary butyl hydroquinone, as well as one or more of the following: n-propyl gallate, ascorbyl palmitate, lecithin, or alpha-tocopherol.

TABLE A
Formulations of the antioxidant compositions.

| First antioxidant | Second antioxidant |
|---|---|
| Formula (I) | synthetic phenolic compound |
| Formula (I) | gallic acid derivative |
| Formula (I) | vitamin C or vitamin C derivative |
| Formula (I) | vitamin E or vitamin E derivative |
| Formula (I) | lecithin |
| Formula (I) | bioflavonoid |
| Formula (I) | terpenoid |
| Formula (I) | tertiary butyl hydroquinone |
| Formula (I) | n-propyl gallate |
| Formula (I) | ascorbyl palmitate |
| Formula (I) | lecithin |
| Formula (I) | alpha-tocopherol |
| Formula (I) | tertiary butyl hydroquinone and n-propyl gallate |
| Formula (I) | tertiary butyl hydroquinone and ascorbyl |
| | palmitate |
| Formula (I) | tertiary butyl hydroquinone and lecithin |
| Formula (I) | tertiary butyl hydroquinone and alpha-tocopherol |
| Formula (I) | tertiary butyl hydroquinone, n-propyl gallate, and |
| | ascorbyl palmitate |
| Formula (I) | tertiary butyl hydroquinone, n-propyl gallate, and |
| | lecithin |
| Formula (I) | tertiary butyl hydroquinone, n-propyl gallate, and |
| | alpha-tocopherol |
| Formula (I) | tertiary butyl hydroquinone, n-propyl gallate, |
| | ascorbyl palmitate, and lecithin |
| Formula (I) | tertiary butyl hydroquinone, n-propyl gallate, |
| | ascorbyl palmitate, and alpha-tocopherol |
| Formula (I) | tertiary butyl hydroquinone, n-propyl gallate, |
| | lecithin, and alpha-tocopherol |
| Formula (I) | tertiary butyl hydroquinone, n-propyl gallate, |
| | ascorbyl palmitate, lecithin, and alpha-tocopherol |
| 6-ethoxy-1,2-dihydro-2,2,4- | tertiary butyl hydroquinone |
| trimethylquinoline | |
| 6-ethoxy-1,2-dihydro-2,2,4- | n-propyl gallate |
| trimethylquinoline | |
| 6-ethoxy-1,2-dihydro-2,2,4- | ascorbyl palmitate |
| trimethylquinoline | |
| 6-ethoxy-1,2-dihydro-2,2,4- | lecithin |
| trimethylquinoline | |
| 6-ethoxy-1,2-dihydro-2,2,4- | alpha-tocopherol |
| trimethylquinoline | |
| 6-ethoxy-1,2-dihydro-2,2,4- | tertiary butyl hydroquinone and n-propyl gallate |
| trimethylquinoline | |
| 6-ethoxy-1,2-dihydro-2,2,4- | tertiary butyl hydroquinone and ascorbyl palmitate |
| trimethylquinoline | |
| 6-ethoxy-1,2-dihydro-2,2,4- | tertiary butyl hydroquinone and |
| trimethylquinoline | lecithin |
| 6-ethoxy-1,2-dihydro-2,2,4- | tertiary butyl hydroquinone and alpha-tocopherol |
| trimethylquinoline | |
| 6-ethoxy-1,2-dihydro-2,2,4- | tertiary butyl hydroquinone, n-propyl gallate, and |
| trimethylquinoline | ascorbyl palmitate |
| 6-ethoxy-1,2-dihydro-2,2,4- | tertiary butyl hydroquinone, n-propyl gallate, and |
| trimethylquinoline | lecithin |
| 6-ethoxy-1,2-dihydro-2,2,4- | tertiary butyl hydroquinone, n-propyl gallate, and |
| trimethylquinoline | alpha-tocopherol |
| 6-ethoxy-1,2-dihydro-2,2,4- | tertiary butyl hydroquinone, n-propyl gallate, |
| trimethylquinoline | ascorbyl palmitate, and lecithin |
| 6-ethoxy-1,2-dihydro-2,2,4- | tertiary butyl hydroquinone, n-propyl gallate, |
| trimethylquinoline | ascorbyl palmitate, and alpha-tocopherol |
| 6-ethoxy-1,2-dihydro-2,2,4- | tertiary butyl hydroquinone, n-propyl gallate, |
| trimethylquinoline | lecithin, and alpha-tocopherol |
| 6-ethoxy-1,2-dihydro-2,2,4- | tertiary butyl hydroquinone, n-propyl gallate, |
| trimethylquinoline | ascorbyl palmitate, lecithin, and alpha-tocopherol |

Other suitable combinations of antioxidants are detailed in the examples.

Typically, the monophasic composition may comprise antioxidant in an amount from about 1% to about 99% by weight, from about 10% to about 80% by weight, and more typically, from about 20% to about 60% by weight. In another embodiment, the monophasic composition may comprise antioxidant in an amount greater than about 5%, greater than about 10%, greater than about 15%, greater than about 20%, greater than about 25%, greater than about 30%, greater than about 35%, greater than about 40%, greater than about 50%, greater than about 55%, greater than about 60%, greater than about 65%, greater than about 70%, or greater than about 75%.

(c) Solvents

The antioxidant composition further comprises a polar solvent. Generally speaking, the polar solvent solubilizes the water-soluble antioxidants. Suitable examples of polar solvents include, but are not limited to, glycerol, isopropyl alcohol, ethyl alcohol, propylene glycol, erythritol, xylitol, sorbitol, maltitol, mannitol, water, or mixtures thereof. In one embodiment the polar solvent may be glycerol. In a preferred embodiment, the polar solvent may comprise glycerol and isopropyl alcohol. The concentration of the polar solvent will vary depending upon the combination of antioxidants in the composition. In general, the percent by volume of the polar solvent may range from about 5% to about 50%. The percent by volume of glycerol may be about 5%, 10%, 15%, 20%, or 25%. The percent by volume of isopropyl alcohol may be about 5%, 10%, 15%, 20%, or 25%. In one embodiment, the percent by volume of glycerol may be about 20-25%. In another embodiment, the percent by volume of glycerol may be about 15-20% and the percent by volume of isopropyl alcohol may be about 10-20%.

In addition, the antioxidant composition further comprises a nonpolar solvent. In general, the nonpolar solvent solubilizes the lipid-soluble antioxidants, and helps make the antioxidant composition miscible in an oil or fat sample. Suitable examples of nonpolar solvents include, but are not limited to, vegetable oils, monoglycerides, diglycerides, triglycerides, and combinations thereof. The vegetable oil may be corn oil, soybean oil, canola oil, cottonseed oil, palm oil, peanut oil, safflower oil, and sunflower oil. The monoglycerides and diglycerides may be isolated and distilled from vegetable oils, or the monoglycerides and diglycerides may be synthesized chemically via an esterification reaction. In one embodiment, the nonpolar solvent may be corn oil. In another embodiment, the nonpolar solvent may comprise corn oil and monoglycerides. The concentration of the nonpolar solvent will vary depending upon the combination of antioxidants in the composition. In general, the percent by volume of the nonpolar solvent may range from about 5% to about 50%. The percent by volume of monoglycerides may be 10%, 15%, 20%, or 25%. The percent by volume of corn oil may be 5%, 10%, 15%, 20%, or 25%. In one embodiment, percent by volume of corn oil may be 15-25%. In another embodiment, the percent by volume of monoglycerides may be 15-20% and the percent by volume of corn oil may be about 5-10%.

(d) Co-Solubilizers

The antioxidant composition may further comprise a co-solubilizer. The co-solubilizer may be a nonionic compound, such as didodecyl thiodipropionate, palmityl citrate, stearyl citrate; an ionic compound, such as a phospholipid; or combinations thereof. The phospholipid may be derived from milk, egg, or soybean. The concentration of the co-solubilizer will vary depending upon the combination of antioxidants in the composition.

Processes for making exemplary monophasic liquid antioxidant composition of the invention are described in the Examples.

### (II) Inhibiting Oxidation of a Lipid Material

The monophasic antioxidant compositions may be utilized to inhibit oxidation in a variety of lipid materials. Generally speaking, an effective amount of the antioxidant composition is contacted with a lipid material by any of a variety of methods commonly known in the art, such as by admixing. In this context, “an effective amount” means the amount of antioxidant composition that is necessary to inhibit the desired degree of oxidation of a selected lipid material. As will be appreciated by a skilled artisan, the amount can and will vary without departing from the scope of the invention. Non-limiting examples of lipid materials in which oxidation may be inhibited include fish oil, fishmeal, vegetable oil, animal fat, and yellow grease. The monophasic antioxidant compositions also may be added to a product containing a lipid material to inhibit its oxidation. Non-limiting examples of products containing lipid materials are discussed below.

(a) Fish Meal Compositions

A further aspect of the invention encompasses fishmeal compositions with the monophasic antioxidant compositions. Generally speaking, fishmeal is a commercial product consisting of the waste from fisheries after the human-consumable material is removed or from whole fish that are not suitable for human consumption. Fish meal may be prepared from vertebrate fish or shellfish, but that derived from shell fish has a lower nutritional value because of the lower protein content of the shell. Non limiting examples of fish or shell fish that may be used for the preparation of fish meal include anchovy, blue whiting, capelin, crab, herring, mackerel, menhaden, pollack, salmon, shrimp, squid, tuna, and whitefish.

Fish meal is the solid material that remains after most of the water and oil have been removed from the starting fish material. Almost all of the fish meal produced today is processed by cooking, pressing, drying and grinding the fish material in machinery designed for the purpose. Typically, vertebrate fish meal contains about 65-75% of protein, 5-12% of fat, 7-9% of water, and 10-20% of minerals and vitamins. Antioxidants may be added to the fish material at any step during the manufacturing process to prevent oxidation of the oils. Once the dried fishmeal is produced, antioxidants are typically added to stabilize the oils in the fishmeal during transport and storage. Fishmeal made from fatty fish is particularly prone to oxidation because of the high concentration of polyunsaturated fatty acids.

The amount of monophasic antioxidant composition added to fishmeal may range from about 0.01% to about 5% by weight. In various preferred embodiments, the concentration is between 0.01% and about 4% by weight; between 0.02% and about 3% by weight; between 0.03% and about 2% by weight; between 0.04% and about 1% by weight; between about 0.05% and about 0.6% by weight; and between about 0.06% and about 0.5% by weight. The effective concentration of the first antioxidant may range from about 10 ppm to about 500 ppm.

Fish meal is typically added to animal feeds and feed supplements as a source of protein, as detailed above in II (g). A major use of fish meal is for feeding farm-raised fish and seafood. Fish meal may also be added to the feed of poultry and swine. Fish meal is high in omega-3 fatty acids, which may deposit in the meat and depot fat of the animal (e.g., chicken eggs with high levels of omega-3 fatty acids). Furthermore, fish meal may be added to the feed for ruminants, cats, and dogs.

(b) Fish Oil Compositions

Also provided are fish oil compositions comprising the monophasic antioxidant compositions of the invention. The monophasic antioxidant composition is miscible in the fish oil. Fish oils are produced whenever fatty fish are processed into meal. Examples of fish oil include, but are not limited to, menhaden oil, anchovy oil, albacore tuna oil, cod liver oil, herring oil, lake trout oil, mackerel oil, salmon oil, and sardine oil.

The amount of monophasic antioxidant composition added to fish oil may range from about 0.01% to about 5% by weight. In various preferred embodiments, the concentration is between 0.01% and about 4% by weight; between 0.02% and about 3% by weight; between 0.03% and about 2% by weight; between 0.04% and about 1% by weight; between about 0.05% and about 0.6% by weight; and between about 0.06% and about 0.5% by weight. The effective concentration of the first antioxidant may range from about 10 ppm to about 500 ppm.

Fish oils may be added as energy sources to aquaculture feeds and animal feeds, as detailed above in II (g). Fish oils may also be used in the paint and varnish industry.

(c) Vegetable Oil Compositions

A further aspect of the invention provides vegetable oil compositions with the monophasic antioxidant compositions. The monophasic antioxidant composition is miscible in the vegetable oil. Vegetable oils are generally extracted from the seeds of plants. The vegetable oil may be algae oil, almond oil, apricot seed oil, argan oil, avocado seed oil, bean oil, canola oil, cashew oil, caster oil, corn oil, cottonseed oil, grapeseed oil, hazelnut oil, hemp seed oil, linseed oil, mustard seed oil, olive oil, palm oil, palm kernel oil, peanut oil, pumpkin seed oil, rice bran oil, safflower oil, sesame oil, soybean oil, sunflower oil, walnut oil, or wheat germ oil.

The amount of monophasic antioxidant composition added to vegetable oil may range from about 0.01% to about 5% by weight. In various preferred embodiments, the concentration is between 0.01% and about 4% by weight; between 0.02% and about 3% by weight; between 0.03% and about 2% by weight; between 0.04% and about 1% by weight; between about 0.05% and about 0.6% by weight; and between about 0.06% and about 0.5% by weight. The effective concentration of the first antioxidant may range from about 10 ppm to about 500 ppm.

Vegetable oils have many uses: they may be used for human consumption; they may be used to make soaps, skin products, and other cosmetics; they may be added to animal feeds or supplements, as detailed in II (g); they may be used as fuels, they may be used in the paint and varnish industry; and they may be used as insulators in the electronics industry.

(d) Animal Fat Compositions

Also provided are animal fat compositions comprising the monophasic antioxidant compositions of the invention. The animal fat composition may be liquid or solid. Non limiting examples of suitable animal fats include poultry fat, beef tallow, mutton tallow, butter, pork lard, whale blubber, and yellow grease (which may be a mixture of vegetable and animal fats).

The amount of monophasic antioxidant composition added to animal fat may range from about 0.01% to about 5% by weight. In various preferred embodiments, the concentration is between 0.01% and about 4% by weight; between 0.02% and about 3% by weight; between 0.03% and about 2% by weight; between 0.04% and about 1% by weight; between about 0.05% and about 0.6% by weight; and between about 0.06% and about 0.5% by weight. The effective concentration of the first antioxidant may range from about 10 ppm to about 500 ppm.

Animal fats may be used for cooking; they may added to animal feed or supplements, as detailed in II (g); they may be used to make soap products; they may be used as lubricants in some industries (e.g., the steel-rolling industry); and they may be used as fuels.

(e) Lipid Compositions for Human Consumption

Without departing from the scope of the invention, also included are lipid compositions for human consumption that are stabilized with monophasic antioxidant compostions that lack the first antioxidant, but have one or more of the second antioxidants. Suitable second antioxidants include tertiary butyl hydroquinone, n-propyl gallate, ascorbyl palmitate, alpha-tocopherol, and lecithin. All of these antioxidants are GRAS and FDA approved for use in human foods. The lipid compositions stabilized with the antioxidants include vegetable oils that may be used for baking, frying, and cooking, or that may be added to salad dressings and other prepared foods. The vegetable oil may be canola oil, corn oil, hazelnut oil, olive oil, peanut oil, safflower oil, sesame oil, soybean oil, sunflower oil, or walnut oil. The lipid compositions may also comprise animal fats, such as butter or lard. Furthermore, the lipid compositions may be fish oil dietary supplements.

(f) Animal Feed Premix or Supplement

Another aspect of the invention comprises an animal feed premix or feed supplement comprising the monophasic antioxidant compositions of the invention. Typically, the premix will be added to various formulations of grain concentrates and forages to formulate an animal feed ration. As will be appreciated by the skilled artisan, the particular premix formulation can and will vary depending upon the feed ration and animal that the feed ration will be fed to. In addition to the monophasic antioxidant compositions of the invention, the premix may further optionally include one or more of a mixture of natural amino acids, analogs of natural amino acids, such as a hydroxyl analog of methionine (“HMTBA”), vitamins and derivatives thereof, enzymes, animal drugs, hormones, effective microorganisms, organic acids, preservatives, flavors, and inert fats.

In one embodiment, the feed premix may include one or more amino acids. Suitable examples of amino acids, depending upon the formulation, include alanine, arginine, asparagines, aspartate, cysteine, glutamate, glutamine, glycine, histidine, isoleucine, leucine, lysine, methionine, phenylalanine, proline, serine, threonine, tryptophan, tyrosine, and valine. Other amino acids usable as feed additives include, by way of non-limiting example, N-acylamino acids, hydroxy homologue compounds, and physiologically acceptable salts thereof, such as hydrochlorides, hydrosulfates, ammonium salts, potassium salts, calcium salts, magnesium salts and sodium salts of amino acids.

In one preferred embodiment, the antioxidant combination may be combined with a hydroxy analog of methionine to form a feed pre-mix. Suitable hydroxyl analogs of methionine include 2-hydroxy-4(methylthio)butanoic acid (“HMTBA” sold by Novus International, St. Louis, Mo. under the trade name Alimet®), its salts, esters, amides, and oligomers. Representative salts of HMTBA include the ammonium salt, the stoichiometric and hyperstoichiometric alkaline earth metal salts (e.g., magnesium and calcium), the stoichiometric and hyperstoichiometric alkali metal salts (e.g., lithium, sodium, and potassium), and the stoichiometric and hyperstoichiometric zinc salt. Representative esters of HMTBA include the methyl, ethyl, 2-propyl, butyl, and 3-methylbutyl esters of HMTBA. Representative amides of HMTBA include methylamide, dimethylamide, ethylmethylamide, butylamide, dibutylamide, and butylmethylamide. Representative oligomers of HMTBA include its dimers, trimers, tetramers and oligomers that include a greater number of repeating units.

Alternatively, the hydroxy analog of methionine may be a metal chelate comprising one or more units of HMTBA together with one or more metal ions. Irrespective of the embodiment, suitable non-limiting examples of metal ions include zinc ions, copper ions, manganese ions, iron ions, chromium ions, cobalt ions, and calcium ions. In one embodiment, the metal ion is divalent. Examples of divalent metal ions (i.e., ions having a net charge of 2⁺) include copper ions, manganese ions, chromium ions, calcium ions, cobalt ions and iron ions. In another embodiment, the metal ion is zinc. In yet another embodiment, the metal ion is copper. In still another embodiment, the metal ion is manganese. In one exemplary embodiment, the metal chelate is HMTBA-Mn. In a further exemplary embodiment, the metal chelate is HMTBA-Cu. In an alternative exemplary embodiment, the metal chelate is HMTBA-Zn. HMTBA-Zn and HMTBA-Cu may be purchased from Novus International, Saint Louis, Mo., sold under the trade names MINTREX® Zn, and MINTREX® Cu, respectively.

In still another embodiment, the feed premix will include vitamins or derivatives of vitamins. Examples of suitable vitamins and derivatives thereof include vitamin A, vitamin A palmitate, vitamin A acetate, β-carotene, vitamin D (e.g., D₂, D₃, and D₄), vitamin E, menadione sodium bisulfite, vitamin B (e.g., thiamin, thiamin hydrochloride, riboflavin, nicotinic acid, nicotinic amide, calcium pantothenate, pantothenate choline, pyridoxine hydrochloride, cyancobalamin, biotin, folic acid, p-aminobenzoic acid), vitamin K, vitamin Q, vitamin F, and vitamin C.

In yet another embodiment, the feed premix will include one or more enzymes. Suitable examples of enzymes include protease, amylase, lipase, cellulase, xylanase, pectinase, phytase, hemicellulase and other physiologically effective enzymes.

In still another embodiment, the feed premix will include a drug approved for use in animals. Non-limiting examples of suitable animal drugs include antibiotics such as tetracycline type (e.g., chlortetracycline and oxytetracycline), amino sugar type, ionophores (e.g., rumensin, virginiamycin, and bambermycin) and macrolide type antibiotics.

In an additional embodiment, the feed premix will include a hormone. Suitable hormones include estrogen, stilbestrol, hexestrol, tyroprotein, glucocorticoids, insulin, glucagon, gastrin, calcitonin, somatotropin, and goitradien.

In a further embodiment, the feed premix will include an effective microorganism. Examples of suitable effective microorganisms include live and dead yeast cultures, which may be formulated as a probiotic. By way of example, such yeast cultures may include one or more of Lactobacillus acidophilus, Bifedobact thermophilum, Bifedobact longhum, Streptococcus faecium, Saccharomyces cerevisiae, Bacillus pumilus, Bacillus subtilis, Bacillus licheniformis, Lactobacillus acidophilus, Lactobacillus casei, Enterococcus faecium, Bifidobacterium bifidium, Propionibacterium acidipropionici, Propionibacteriium freudenreichii, Aspergillus oryzae, and Bifidobacterium pscudolongum.

In yet another embodiment, the premix will include an organic acid. Suitable organic acids include malic acid, propionic acid and fumaric acid.

In an additional embodiment, the feed premix will include a substance to increase the palatability of the feed ration. Suitable examples of such substances include natural sweeteners, such as molasses, and artificial sweeteners such as saccharin and aspartame.

In a further embodiment, the feed premix will include an energy source in the form of oils or fats. Suitable examples of oils and fats include fish oil, vegetable oil, and animal fat. Premixes for ruminants, may include a ruminally inert fat, such as megalac, alifet, and carolac. Some commercially available bypass fats are described, for example, in U.S. Pat. Nos. 5,182,126; 5,250,307; 5,391,787; 5,425,963; and 5,456,927 which disclose C14-C22 fatty acids, their glycerides, or their salts including, but not limited to, palmitic, oleic, linoleic, stearic, and lauric compounds.

As will be appreciated by the skilled artisan, any of the substances that may be included in the premix of the invention can be used alone or in combination with one another. The concentration of these additives will depend upon the application but, in general, will be between about 0.0001% and about 10% by weight of the dry matter, more preferably between about 0.001% and about 7.5%, most preferably between about 0.01% and about 5%.

The feed premix or supplement may contain a monophasic antioxidant composition of the invention to prevent oxidation of the lipid materials. As will be appreciated by a skilled artisan, the concentration of monophasic antioxidant composition added to a particular feed premix or supplement can and will vary without departing from the scope of the invention. Generally, the concentration of monophasic antioxidant added is between about 0.01% and about 5% by weight. In various preferred embodiments, the concentration is between 0.01% and about 4% by weight; between 0.02% and about 3% by weight; between 0.03% and about 2% by weight; between 0.04% and about 1% by weight; between about 0.05% and about 0.6% by weight; and between about 0.06% and about 0.5% by weight. The effective concentration of the first antioxidant may range from about 10 ppm to about 500 ppm.

(g) Animal Feed Rations

A further aspect of the invention provides animal feed rations that contain the monophasic antioxidant compositions to prevent the oxidation of lipid materials. In particular, the monophasic antioxidant compositions may be added to inhibit the oxidation of fish oil, fish meal, vegetable oils and animal fats. For example, fish oils used in animal feeds include menhaden oil, anchovy oil, albacore tuna oil, cod liver oil, herring oil, lake trout oil, mackerel oil, salmon oil, and sardine oil. Commonly used fish meals include menhaden meal, anchovy meal, herring meal, pollack meal, salmon meal, tuna meal, and whitefish meal. Vegetable oils used in animal feeds include canola oil, corn oil, cottonseed oil, palm oil, safflower oil, soybean oil, and sunflower oil. Sources of animal fats include poultry fat, beef tallow, butter, pork lard, and whale blubber. Another source of fats added to feed rations is yellow grease, which includes is the waste grease from restaurants and low-grade fats from rendering plants.

Animals for which the feed compositions described herein may be used include ruminants such as dairy cows, lactating dairy cows, dairy calves, beef cattle, sheep, and goats; aquaculture such as fish and crustaceans (including, but not limited to, salmon, shrimp, carp, tilapia and shell fish); livestock such as swine and horses; poultry such as chickens, turkeys, and hatchlings thereof; and companion animals such as dogs and cats. Suitable examples of feed rations for a variety of these animals are described in more detail below.

As will be appreciated by a skilled artisan, the concentration of monophasic antioxidant composition added to a particular feed composition can and will vary without departing from the scope of the invention. Generally, the concentration of monophasic antioxidant added is between about 0.01% and about 5% by weight. In various preferred embodiments, the concentration is between 0.01% and about 4% by weight; between 0.02% and about 3% by weight; between 0.03% and about 2% by weight; between 0.04% and about 1% by weight; between about 0.05% and about 0.6% by weight; and between about 0.06% and about 0.5% by weight. The effective concentration of the first antioxidant may range from about 10 ppm to about 500 ppm.

The exact formulation of the above-mentioned animal feed composition is not critical to the present invention. Feed ingredients are selected according to the nutrient requirements of the particular animal for which the feed is intended; these requirements depend, interalia, upon the age and stage of development of the animal, the sex of the animal, and other factors. Feed ingredients may be grouped into eight classes on the basis of their composition and their use in formulating diets: dry forages and roughages; pasture, range plants and forages fed fresh; silages; energy feeds; protein supplements; mineral supplements; vitamin supplements; and additives. See National Research Council (U.S.) Subcommittee on Feed Composition, United States-Canadian Tables of Feed Composition, 3d rev., National Academy Press, pp. 2, 145 (1982). These classes are, to a certain extent, arbitrary, as some feed ingredients could be classified in more than one class. Typically, a feed formulation will also depend upon the costs associated with each ingredient, with the least-expensive composition of ingredients that gives the needed nutrients being the preferred formulation.

In one embodiment, the animal ration is formulated for poultry. As noted above, feed formulations depend in part upon the age and stage of development of the animal to be fed, Leeson and Summers (Nutrition of the Chicken, 4^{th} ed., pp. 502-510, University Books 2001) describe several representative poultry diets for pullets, layers, broilers and broiler breeders. For example, most chicken diets contain energy concentrates such as corn, oats, wheat, barley, or sorghum; protein sources such as soybean meal, other oilseed meals (e.g., peanut, sesame, safflower, sunflower, etc.), cottonseed meal, animal protein sources (meat and bone meal, dried whey, fish meal, etc.), grain legumes (e.g., dry beans, field peas, etc.), and alfalfa; and vitamin and mineral supplements, if necessary (for instance, meat and bone meal is high in calcium and phosphorous, and thus these minerals do not need to be supplemented in a feed ration containing meat and bone meal). The relative amounts of the different ingredients in poultry feed depend in part upon the production stage of the bird. Starter rations are higher in protein, while grower and finisher feeds can be lower in protein since older birds require less protein.

In another embodiment, the animal ration is formulated for a ruminant animal. The nutrient and energy content of many common ruminant feed ingredients have been measured and are available to the public. The National Research Council has published books that contain tables of common ruminant feed ingredients and their respective measured nutrient and energy content. Additionally, estimates of nutrient and maintenance energy requirements are provided for growing and finishing cattle according to the weight of the cattle. National Academy of Sciences, Nutrient Requirements of Beef Cattle, Appendix Tables 1-19, 192-214, (National Academy Press, 2000); Nutrient Requirements of Dairy Cattle (2001), each incorporated herein in its entirety. This information can be utilized by one skilled in the art to estimate the nutritional and maintenance energy requirements of growing cattle or dairy cattle and determine the nutrient and energy content of ruminant feed ingredients.

In one embodiment, the feed ration will be formulated for a dairy cow. In practice, ruminants are typically fed as a ration, commonly referred to as a total mixed ration (TMR), which consists of a forage portion and a grain concentrate portion. Any of the forage and grain concentrates detailed herein or otherwise known in the art may be utilized. As will be appreciated by a skilled artisan, a feed ration for a dairy cow can and will vary greatly depending upon the cow's stage of production. In this context, stage of production not only refers to whether a dairy cow is dry or lactating, but also the duration of time the cow has been in the dry cycle or the lactation cycle. Milestones in the stage of production include the first 35 days dry, known as “far off;” the last 21 days dry, known as “close-up;” day 0 to day 14 of lactation, known as “fresh;” day 14 to day 80 of lactation, known as “peak milk;” days 80 to 200 of lactation, known as “peak intake;” and days 200 to 330 of lactation. Suitable rations for dairy cattle for the first 35 days dry, day 0 to 14 of lactation and day 14 to 80 of lactation are detailed below.

An example of a suitable dairy cow feed ration for a cow in the first 35 days of the dry cycle is as follows:

| | Percent by Weight (DM basis) |
|---|---|
| Ingredient | of Total Feed Composition |
| Steamrolled Corn | 8.0 |
| Wheat straw | 8.5 |
| Alfalfa hay | 38.0 |
| Corn silage | 41.0 |
| Trace Mineral Salts | 4.5 |

A suitable example of a dairy cow feed ration for a cow at day 0 to 14 of the lactation cycle is as follows:

| | Percent by Weight (DM basis) |
|---|---|
| Ingredient | of Total Feed Composition |
| Steamrolled Corn | 8.0 |
| Soybean meal (44%) | 7.5 |
| Alfalfa hay | 17.0 |
| Corn silage | 47.0 |
| Trace Mineral Salts | 4.5 |

An example of a suitable dairy cow feed ration for a cow at day 14 to 80 of the lactation cycle is as follows:

| | Percent by Weight (DM basis) |
|---|---|
| Ingredient | of Total Feed Composition |
| Steamrolled Corn | 15.0 |
| Soybean meal (44%) | 13.0 |
| Alfalfa hay | 22.0 |
| Corn silage | 21.0 |
| Distillers grains | 8.0 |
| Whole Cottonseed | 10.0 |
| Soybean hulls | 6.5 |
| Trace Mineral Salts | 4.5 |

A feed ration may also be formulated to meet the nutritional requirements of non-dairy cattle, and in particular, feedlot cattle. The percentage of each type of component in the cattle diet (i.e. grain to roughage ratio) depends upon the dietary requirements of the particular animal. By way of example, a feed composition typically fed to feedlot cattle on an intermediate or growing diet may include:

| | Percent by Weight of |
|---|---|
| Ingredient | Total Feed Composition |
| Dehydrated Alfalfa Meal | 25.0 |
| Cottonseed Hulls | 5.0 |
| Steamrolled Corn | 60.0 |
| Soybean meal (44%) | 3.0 |
| Calcium Carbonate | 1.0 |
| Sodium Tripolyphosphate | 0.5 |
| Cane Molasses | 5.0 |
| Trace Mineral Salts | 0.5 |

The intermediate diet contains a moderate energy to roughage ratio and is fed to cattle during their growth stage. After the intermediate diet, a higher energy finishing diet is substituted until the cattle are ready for slaughter. A typical finishing diet may include:

| | Percent by Weight of |
|---|---|
| Ingredient | Total Feed Composition |
| Dehydrated Alfalfa Meal | 5.0 |
| Cottonseed Hulls | 10.0 |
| Steamrolled Corn | 74.8 |
| Soybean meal (44%) | 3.0 |
| Calcium Carbonate | 0.7 |
| Sodium Tripolyphosphate | 0.3 |
| Cane Molasses | 5.0 |

In another embodiment, the animal ration is formulated for aquatic animals. As appreciated by a skilled aquaculturist, the feed formulation depends upon the organism being cultured and the developmental stage of the organism. Typical aquaculture preparations contain energy sources, e.g., protein from animal blood meal, meat and bone meal, poultry meal, crab meal, fish meal, shrimp meal, squid meal, and krill; protein/carbohydrates from plants (e.g., alginates, canola, corn, corn gluten, cottonseed meal, kelp meal, molasses, legumes, peanut meal, rice, soybeans, soy protein concentrate, soybean meal, wheat, and wheat gluten); and oils (e.g., fish oil, vegetable oil). The feed preparation may be further supplemented with amino acids (e.g., arginine, histidine, isoleucine, lysine, methionine, phenylalanine, threonine, tryptophan, and valine); vitamins, minerals, enzymes, mycotoxin inhibitors, ammonia binders (e.g., botanical binders, clay mineral binders), emulsifiers, carotenoids, sterols, flavor enhancers, neutraceuticals, immunostimulants, and probiotics.

In another embodiment, the animal ration is formulated for swine. The feed formulation will vary for piglets, grower pigs, gestating sows, and lactating sows. Swine feed formulations typically comprise grains (e.g., corn, barley, grain sorghum, oats, soybeans, wheat, etc.), crude proteins (e.g., fish meal, gluten meal, meat meal, soybean meal, tankage, which is the residue that remains after rendering fat in a slaughterhouse, etc.), crude fat (e.g., fish oils, vegetable oils, animal fats, yellow grease, etc.), supplemental amino acids (e.g., lysine, methionine or methionine analogs, etc), vitamins, minerals, mycotoxin inhibitors, antifungal agents, and pharma/nutraceuticals.

### Definitions

Unless otherwise indicated, the alkyl groups described herein are preferably lower alkyl containing from one to eight carbon atoms in the principal chain and up to 20 carbon atoms. They may be straight or branched chain or cyclic and include methyl, ethyl, propyl, isopropyl, butyl, hexyl and the like. The term “alkoxy” refers to an alkyl group linked to oxygen.

The term “AOM” stands for the Active Oxygen Method. The method measures the level of peroxides in an oil or fat sample.

The phrase “glycerol esters of fatty acids having chain lengths of about 14 to 24 carbons” as used herein refers to glycerides that occur naturally in oils, in which one or more of the hydroxyl groups of glycerol has been replaced with a fatty acid to form a mono-, di-, or triglyceride. These glycerides are present in vegetable oils. These glycerides may be isolated from vegetable oils (e.g., DIMODAN® a registered trade name of distilled monoglycerides from Danisco A/S, Copenhagen). These glycerides may be synthesized by an esterification reaction between glycerol and fatty acids.

The term “lecithin” as used herein refers to a mixture of glycolipids, triglycerides, and phospholipids (e.g., phosphatidyl choline, phosphatidyl inositol, phosphatidyl ethanolamine, phosphatidyl serine, and phosphatidic acid).

The term “lipid material” as used herein refers to any material comprising mono-, di-, and tri-glycerides. Lipids or lipid materials are not soluble in water, but are soluble in organic solvents (e.g., ether, chloroform, hexane, etc.). Lipid materials enriched in glycerides include fish oils, fish meal, vegetable oils, animal fats, and yellow grease. The term also encompasses derivatives of lipid materials and lipid-derived materials.

The term “non-polar solvent” as used herein refers to a mixture comprising glycerol esters of fatty acids having chain lengths of about 14 to about 24 carbons.

The term “oxidative stability” refers to the ability to slow down the oxidation of an oil or fat.

The term “OSI” stands for Oxidative Stability Index method. The method measures the induction period (hours) of the oil or fat sample.

The term “ppm” stands for parts per million.

As various changes could be made in the above compounds, products and methods without departing from the scope of the invention, it is intended that all matter contained in the above description and in the examples given below, shall be interpreted as illustrative and not in a limiting sense.

### EXAMPLES

The following examples illustrate various embodiments of the invention.

### Example 1

### Effectiveness of Individual Antioxidants to Stabilize Menhaden Oil

The ability of individual antioxidants to stabilize menhaden oil was tested using several methods. One method was the Oxidation Stability Index (OSI) method, which determines the relative resistance of fat and oil samples to oxidation (American Oil Chemists Society (AOCS) Official Method Cd 12b-92, American Oil Chemists Society, Illinois, 1996). Briefly, before lipids and oils start to oxidize a resistance has to be overcome, after which the oxidation accelerates and becomes rapid. The time needed to overcome the resistance is referred to as the “induction period.” During the OSI method, a stream of air is passed through a sample of oil with or without an antioxidant at 70° C. The effluent air from the oil or lipid sample is bubbled through a test vessel containing deionized water, whose conductivity is continuously monitored. As the oil oxidizes, volatile organic acids are generated and become trapped in the water, thereby increasing its conductivity. The OSI value is defined as the induction period in hours and mathematically represents the inflection point (second derivative) of the curve (conductance vs. time) that reflects the maximum change in the oxidation rate. The higher the OSI value, the more stable the oil.

The Active Oxygen Method (AOM) was also used to test the activity of the antioxidants. This method is also approved by the AOCS (AOCS Official Method Cd 12-57, American Oil Chemists Society, Chicago, 1993). In this method, air is bubbled into the test sample to accelerate oxidation and then analyzed for peroxides content. The lower the value, the more stable the oil. For animal-derived lipids it has been shown that when the peroxides value reaches 20 Meq/kg fat the product is considered rancid.

The following antioxidants were tested for their ability to stabilize menhaden oil using the OSI method: 5% ethoxyquin (EQ), 10% tert-butyl hydroquinone (TBHQ), 10% n-propyl gallate (PG), 10% ascorbyl palmitate (AP), 15% natural mixed tocopherols (NMTs), and 10% lecithin (LE). The OSI values are presented in Table 1.

TABLE 1
Concentration of the antioxidants tested and their activity.

| | | ppm in oil | |
|---|---|---|---|
| Antioxidant | % composition | sample | OSI (hr) |
| None | — | — | 7.5 |
| EQ | 5 | 100 | 10 |
| TBHQ | 10 | 200 | 52 |
| PG | 10 | 200 | 18 |
| AP | 10 | 200 | 10 |
| NMT | 15 | 300 | 17 |
| LE | 10 | 200 | 9 |

### Example 2

### Effectiveness of Mixed Antioxidant Formulations to Stabilize Menhaden Oil

Different antioxidants were combined with EQ to find a highly effective antioxidant formulation. The concentrations of the antioxidants were the same as those used in Example 1; the balance of the solution was corn oil. The compositions of the 32 different formulations are shown in Table 2. The formulations were tested for their ability to stabilize menhaden oil, using both the OSI and AOM methods as described above. Each formulation was tested at 2000 ppm (0.2% of the formulation was added to the oil sample). The results are presented in Table 2.

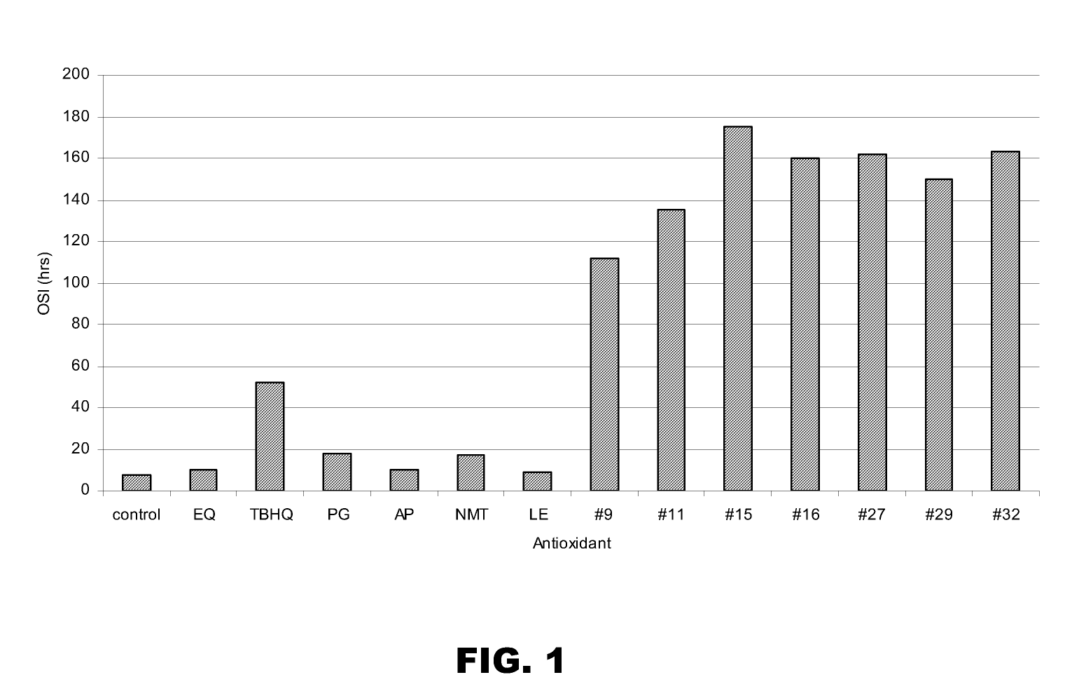

The combination of EQ+TBHQ (#9) increased the induction time to 112.3 hr, which is much greater than the additive effect of either antioxidant used alone (10 hr and 52 hr for EQ and TBHQ, respectively, Table 1). The addition of PG (#13), AP (#11), or LE (#25) further boosted the effectiveness of any EQ+TBHQ formulation. Thus, the combination of multiple antioxidants along with EQ+TBHQ provided the best formulations (e.g., #15, #27). FIG. 1 presents the OSI values of the individual antioxidants and some of the combination formulations.

TABLE 2
Stabilization of menhaden oil.

| | | | | | | | OSI | AOM |
|---|---|---|---|---|---|---|---|---|
| # | EQ | TBHQ | PG | AP | NMT | LE | (hr) | (meq/kg) |
| Control | | | | | | | 7.5 | 38 |
| 1 | + | | | | | | 10.0 | 33 |
| 2 | + | | | | + | | 12.2 | 33 |
| 3 | + | | | + | | | 16.9 | 2 |
| 4 | + | | | + | + | | 19.9 | 2 |
| 5 | + | | + | | | | 46.5 | 4 |
| 6 | + | | + | | + | | 49.9 | 4 |
| 7 | + | | + | + | | | 74.0 | 2 |
| 8 | + | | + | + | + | | 44.8 | 2 |
| 9 | + | + | | | | | 112.3 | 3 |
| 10 | + | + | | | + | | 102.9 | 3 |
| 11 | + | + | | + | | | 135.4 | 2 |
| 12 | + | + | | + | + | | 133.1 | 2 |
| 13 | + | + | + | | | | 118.3 | 3 |
| 14 | + | + | + | | + | | 107.0 | 3 |
| 15 | + | + | + | + | | | 174.6 | 2 |
| 16 | + | + | + | + | + | | 160.1 | 2 |
| 17 | + | | | | | + | 11.4 | 5 |
| 18 | + | | | | + | + | 14.2 | 9 |
| 19 | + | | | + | | + | 18.3 | 2 |
| 20 | + | | | + | + | + | 23.4 | 4 |
| 21 | + | | + | | | + | 57.9 | 3 |
| 22 | + | | + | | + | + | 54.5 | 3 |
| 23 | + | | + | + | | + | 76.5 | 2 |
| 24 | + | | + | + | + | + | 65.3 | 2 |
| 25 | + | + | | | | + | 135.1 | 2 |
| 26 | + | + | | | + | + | 131.6 | 2 |
| 27 | + | + | | + | | + | 161.6 | 2 |
| 28 | + | + | | + | + | + | 135.3 | 2 |
| 29 | + | + | + | | | + | 149.7 | 2 |
| 30 | + | + | + | | + | + | 53.9 | 3 |
| 31 | + | + | + | + | | + | 159.7 | 2 |
| 32 | + | + | + | + | + | + | 163.0 | 2 |

### Example 3

### Mixed Antioxidant Formulations Stabilize Anchovy Oil

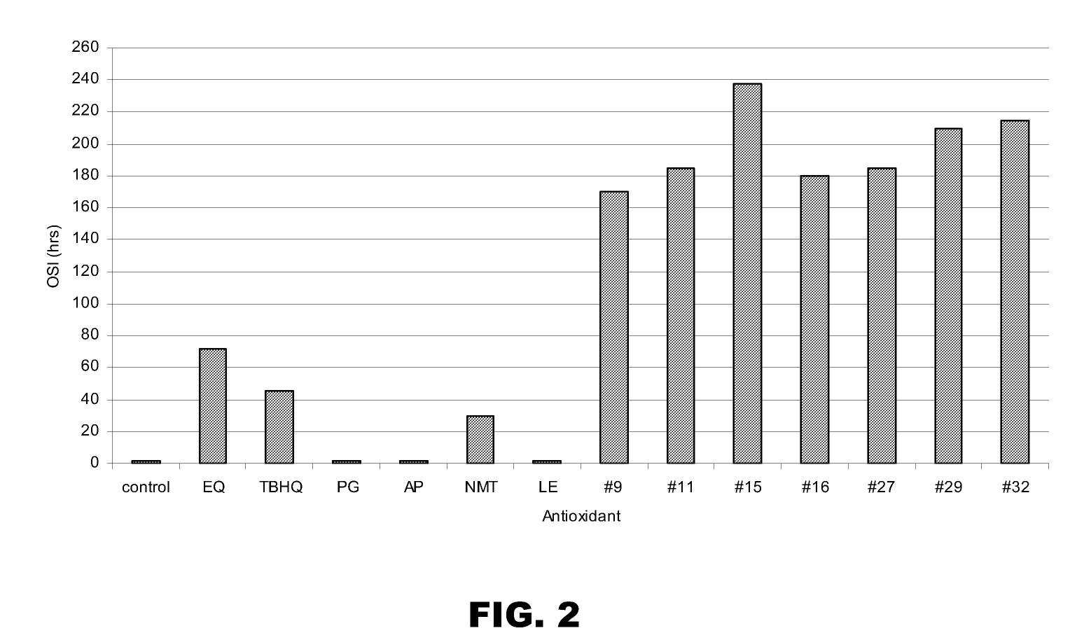

The individual antioxidants and some of the combination formulations were tested for their ability to prevent the oxidation of anchovy oil using the OSI method, as described in Example 1. Each formulation was tested at 2000 ppm (0.2% of the formulation was added to the oil sample). As shown in FIG. 2, formulations that contained EQ and TBHQ significantly increased the OSI values. Formulation #15 (EQ+TBHQ+PG+AP) provided the best protection.

### Example 4

### Mixed Antioxidant Formulations Stabilize Soybean Oil

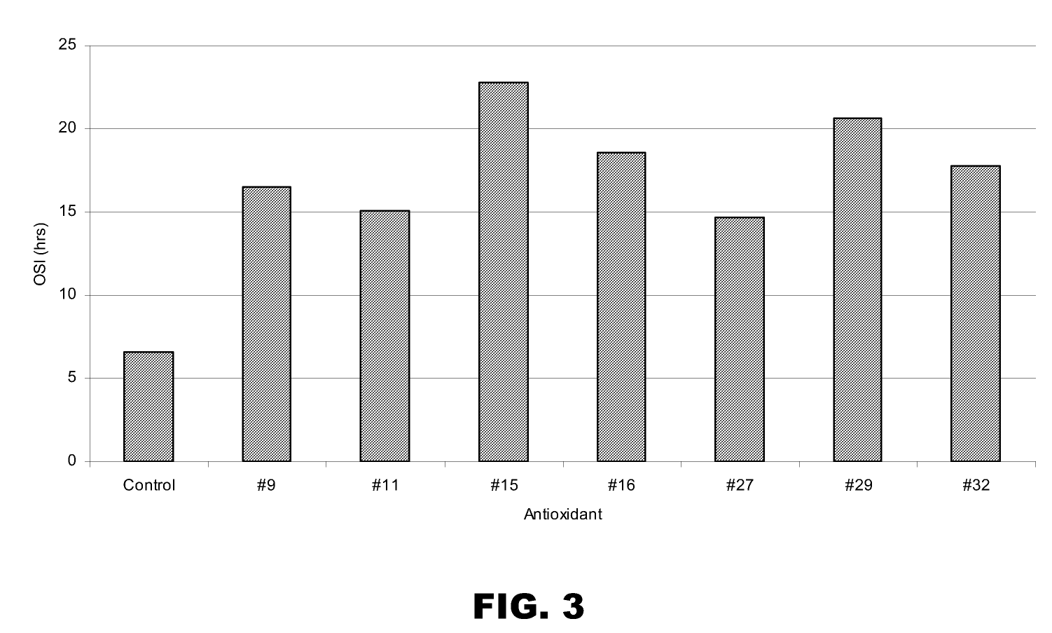

Some of the combination formulations were tested for their ability to stabilize a vegetable oil. The stability of soybean oil in the absence or presence of selected formulations was tested using the OSI method as described in Example 1. Each formulation was tested at 500 ppm (0.05% of the formulation added to the oil sample) and 1000 ppm (0.1% of the formulation added to the oil sample). The OSI values are presented in Table 3; and the OSI values at the 1000 ppm level are presented in FIG. 3. Formulations #15 (EQ+TBHQ+PG+AP) #29 (EQ+TBHQ+PG+LE) were particularly effective at stabilizing soybean oil.

TABLE 3
Stabilization of soybean oil.

| | OSI (hr) | | |
|---|---|---|---|
| Formulation | None | (500 ppm) | (1000 ppm) |
| Control | 6.6 | | |
| EQ alone | | 11.6 | |
| #9 | | 12.7 | 16.5 |
| #11 | | 11.0 | 15.1 |
| #15 | | 15.8 | 22.8 |
| #16 | | 12.3 | 18.6 |
| #27 | | 10.6 | 14.7 |
| #29 | | 14.4 | 20.6 |
| #32 | | 12.8 | 17.8 |

### Example 5

### Mixed Antioxidant Formulations Stabilize Poultry Fat

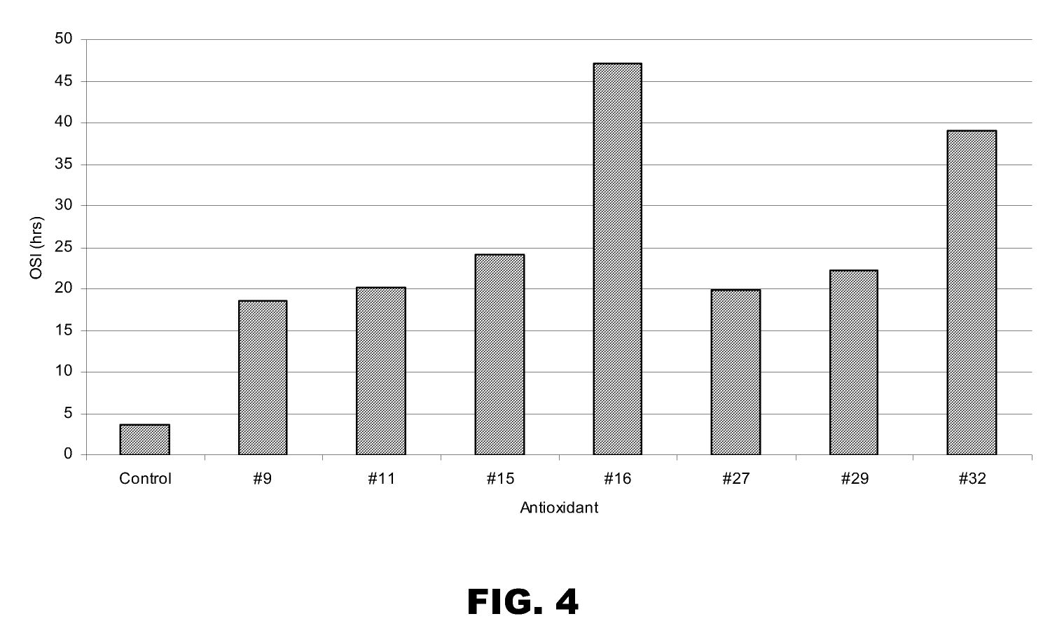

The ability of selected antioxidant formulations to stabilize an animal fat was also tested. The oxidative stability of poultry fat in the absence or presence of selected formulations was tested using the OSI method as described in Example 1. Each formulation was tested at 500 ppm (0.05% of formulation added to oil sample) and 1000 ppm (0.1% of formulation added to oil sample). The OSI values are presented in Table 4, and the values at the 1000 ppm level are graphically presented in FIG. 4. Formulations that contained tocopherols (#16 and #32) were very effective in stabilizing poultry fats.

TABLE 4
Stabilization of poultry fat.

| | OSI (hr) | | |
|---|---|---|---|
| Formulation | None | (500 ppm) | (1000 ppm) |
| Control | 3.58 | | |
| EQ alone | | 26.7 | |
| #9 | | 9.0 | 18.5 |
| #11 | | 8.9 | 20.2 |
| #15 | | 14.1 | 24.2 |
| #16 | | 23.1 | 47.1 |
| #27 | | 11.6 | 19.9 |
| #29 | | 13.1 | 22.2 |
| #32 | | 19.9 | 39.0 |

### Example 6

### Mixed Antioxidant Formulations Stabilize Biodiesel

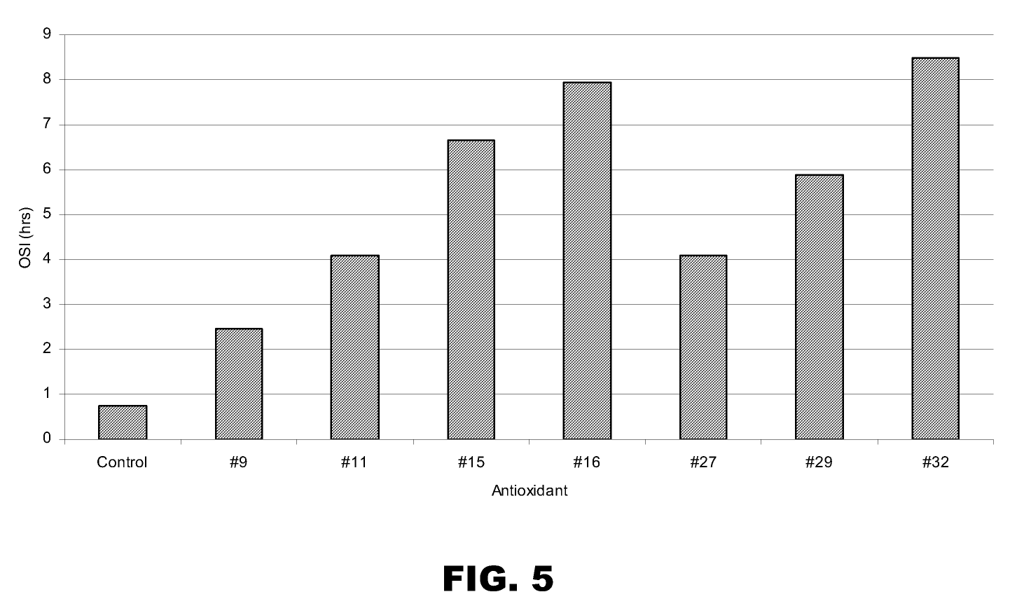

The ability of selected antioxidant formulations to stabilize biodiesel was also tested. The oxidative stability of biodiesel in the absence or presence of selected formulations was tested using the OSI method as described in Example 1. Each formulation was tested at 200 ppm (0.02% of the formulation added to the oil sample) and 500 ppm (0.05% of the formulation added to the oil sample). The OSI values are presented in Table 5; and the values at the 500 level are graphically presented in FIG. 5.

TABLE 5
Stabilization of biodiesel.

OSI (hr)

| Formulation | None | (200 ppm) | (500 ppm) |
|---|---|---|---|
| Control | 0.75 | | |
| #9 | | 1.35 | 2.45 |
| #11 | | 1.80 | 4.10 |
| #15 | | 2.9 | 6.65 |
| #16 | | 3.45 | 7.95 |
| #27 | | 1.85 | 4.1 |
| #29 | | 2.65 | 5.90 |
| #32 | | 3.50 | 8.50 |

### Example 7

### Preparation of a Stable, Homogeneous, Monophasic Antioxidant Formulation

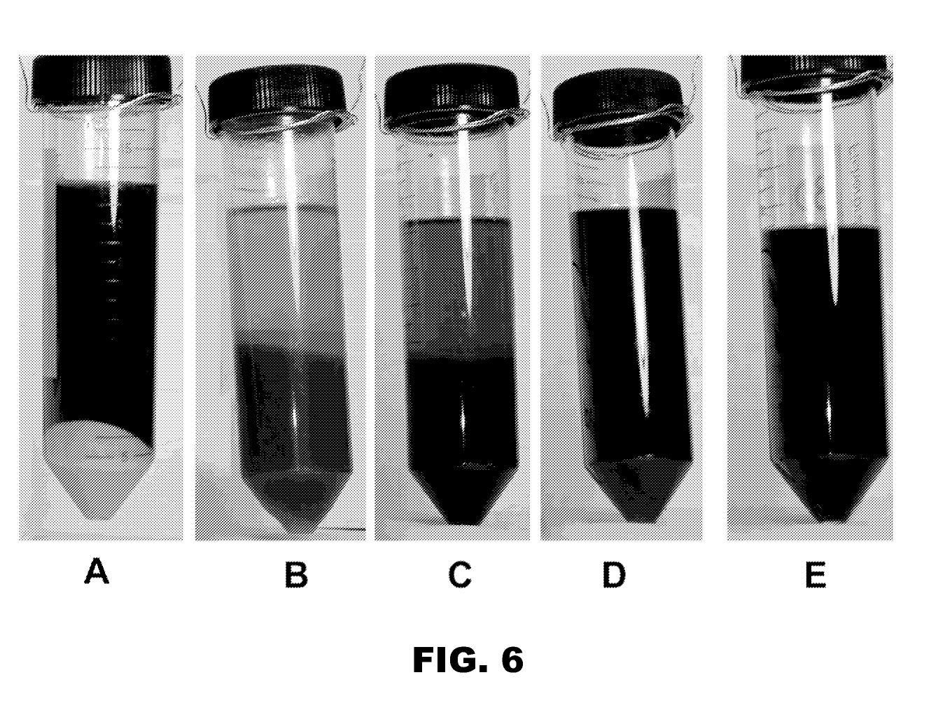

After storage at room temperature for several weeks, the original formulations, described above, displayed some precipitation (FIG. 6A). To create a stable monophasic formulation, the method of preparation was modified to include a polar solvent. For this, the antioxidants (EQ, PG) were mixed with either propylene glycol or glycerol (from 5-25%) and heated to 85-100° C. The lipid-soluble antioxidants (TBHQ, AP, NMT, LE) were added to corn oil (5-30%) and heated to 85-100° C. The water-soluble mixture was then mixed into the lipid soluble mixture at a speed of 13,000-25,000 rpm for 3 minutes. The formulations were centrifuged at 3,600 rpm for 15 minutes. As shown in FIGS. 6B and 6C, the addition of a polar solvent eliminated the precipitation, but created a biphasic solution.

Next, monoglycerides (e.g., distilled monoglycerides, DIMODAN®, Danisco A/S, Copenhagen, Denmark) were substituted for some of the corn oil. As shown in FIGS. 6D and 6E, monophasic solutions were generated. Even at the optimal concentrations of 25% glycerol and 25% monoglycerides, some crystals formed after several weeks of storage. The addition of isopropyl alcohol (10-20%) to replace some of the glycerol and monoglycerides prevented this nucleation. A more stable formulation of lower viscosity and better clarity was generated.

The method of preparation was further modified in that all the ingredients, i.e., the antioxidants, the polar solvents (glycerol and isopropyl alcohol), and the nonpolar solvents (isolated glycerides, corn oil), were added to a mixing container and the mixture was heated to 85-95° C. with mixing (3,000-6,500 rpm) for 3 minutes. To avoid excessive shear and minimize auto-oxidative stress, the blend was subjected to gentle mixing at 50-100 rpm while keeping the temperature at the same level. The time of mixing was extended to about 30 minutes, however.

### Example 8

### Production of an Antioxidant Formulation for the Stabilization of Fishmeal and Fish Oil

Formulation #29 was selected for further study with regard to its ability to stabilize fishmeal and fish oil. The concentrations of the polar and nonpolar solvents of this formulation were adjusted such that a clear, amber-colored liquid antioxidant formulation was obtained. Table 6 presents the complete composition of the formulation, which is also called B-29.

TABLE 6
Composition of B-29.

| INGREDIENT | AMOUNT (wt %) | REMARK |
|---|---|---|
| Ethoxyquin (EQ) | 5 | 95% purity min (liquid) |
| TBHQ | 10 | (powder) |
| Propyl gallate (PG) | 10 | (powder) |
| Lecithin (LE) | 11 | Feed grade (liquid) |
| Glycerol | 10 | Food/Feed grade (liquid) |
| Distilled monoglycerides | 31 | DIMODAN ® |
| | | (viscous paste-liquid) |
| Corn oil | 23 | (liquid) |

To prepare the formulation, the corn oil was added to a mixing vessel and heated to 45°-93° C. The corn oil was mixed (about 100-300 rpm), the temperature was maintained, and the ingredients were added in the following order: ethoxyquin, propyl gallate, TBHQ, lecithin, glycerol, and monoglycerides. Once the ingredients appeared to be in solution, the mixing speed was reduced to about 50-100 rpm to allow for total dissolution of the water-soluble propyl gallate in the solubilizing surface active agents (lecithin and monoglycerides). The temperature was maintained at 45°-93° C. and the solution was mixed for about 1 hour.

### Example 9

### Efficacy of B-29 in Stabilizing Menhaden Fishmeal

The effectiveness of the new antioxidant formulation, B-29, to stabilize fishmeal was compared to that of a commercially available antioxidant formulation containing a higher concentration of ethoxyquin (i.e., SANTOQUIN®). For this study, fishmeal was stored under conditions (i.e., 50° C.) that accelerated its oxidation. Ethoxyquin was used at 735 ppm and B-29 was tested at two levels (925 ppm and 1790 ppm). The effects of the antioxidants were compared to a sample with no added antioxidants (i.e., negative control).

Samples (270 g) of menhaden fishmeal (Daybrook Fisheries Inc, Empire, La., US) were placed in open-mouth jars and stored in a circulated air incubator at 50° C. At regular intervals over 24 weeks, samples were removed and the following parameters were measured: moisture level, peroxide value, fat level (using a petroleum either extraction method or the Bligh & Dyer lipid extraction method), and iodine value.

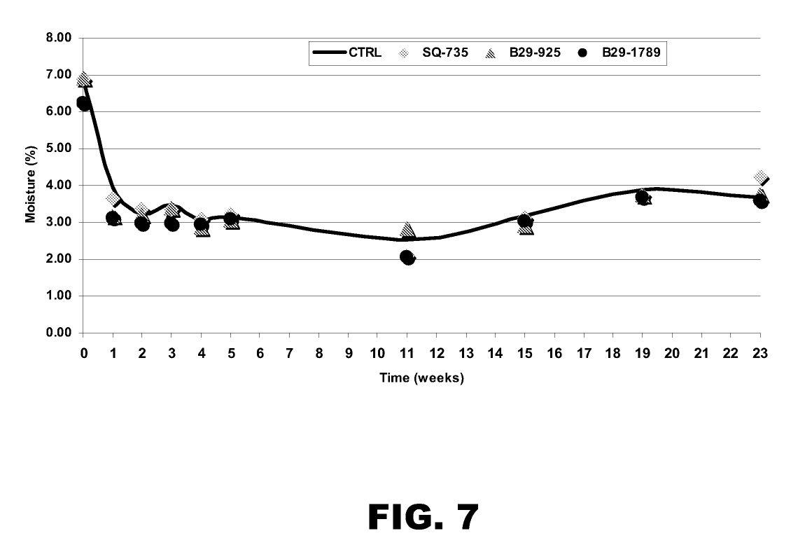

The percent of moisture in the four samples is presented in FIG. 7. After one week at 50° C., all four of the samples reached equilibrium levels that stayed around 3.5% for the duration of the study. The percentage of moisture increased slightly, however, during the last several weeks of the trial (this increase may have been due to the unusually humid conditions in the laboratory at the time).

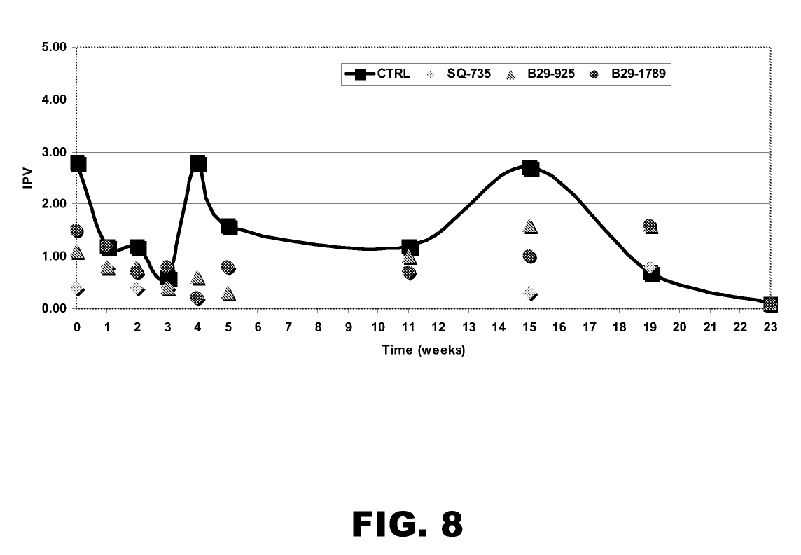

The peroxide value (PV) (also known as the initial peroxide value or IPV) is a measure of the state of rancidity of a sample. Peroxides play important roles in catalyzing autoxidation, which leads to the generation of aldehydes, volatile organic acids, ketones, etc. The higher the peroxide value the lower the induction period and the higher the rate of autoxidation. Peroxides were measured indirectly under standard conditions and are expressed a milliequivalents of peroxide per kilogram of fat (Meq/kg). As shown in FIG. 8, the peroxide values of all the treatment condition showed no significant differences and remained below 3 Meq/kg. Since this analysis of peroxide values was inconclusive, additional tests were required to elucidate the effects of the different antioxidants.

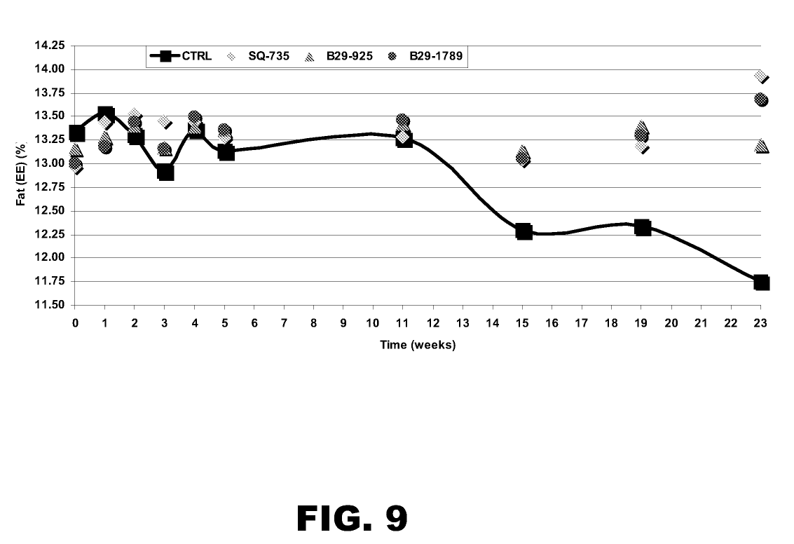

The percentage of fat declines in a sample when it undergoes oxidation. The amount of fat (oil) in the fishmeal samples was measured using a petroleum ether extraction method. The technique relies on specific extractive solvents, such as petroleum ether and methanol, to extract the fat and quantify it. As can be seen in FIG. 9, the percentage of extracted fat of the control sample started to decline after week 11 and continued to decline until the end of the study. This decline indicates that oxidation had taken place in the control sample and the fat had been transformed into aldehydes, fatty acids, ketones, etc. In contrast, the levels of fat in the antioxidant-treated samples were quite stable over the course of the study. Thus, the B-29 formulation comprising a lower concentration of ethoxyquin was just as effective in preventing fat oxidation as the higher concentration of ethoxyquin.

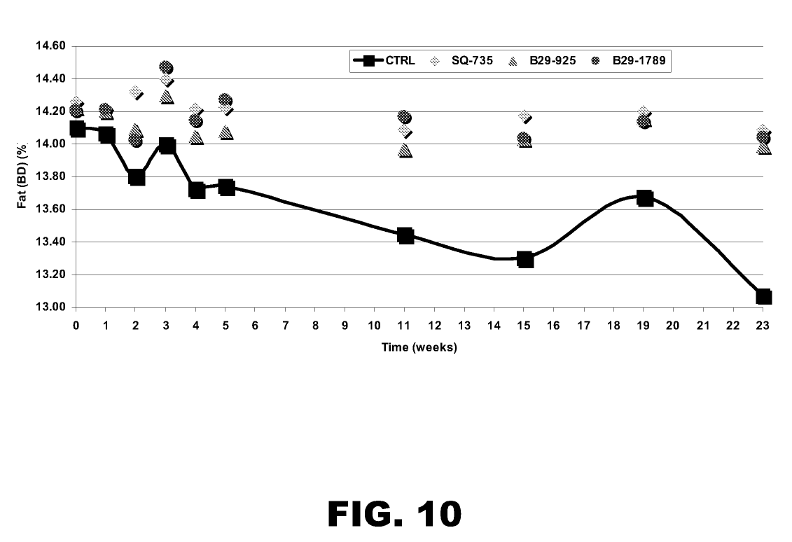

The fat content of the fishmeal was also evaluated using the Bligh & Dyer method, which mainly uses chloroform to extract the fats. The Bligh & Dyer method analyzes the total amount of fat, i.e., fats hydrolyzed from phospholipids, oxidized fats, as well as mono-, di-, and triglycerides. The percentages of fat in the different samples are presented in FIG. 10. Again the control sample had significantly reduced levels of fat starting around week 11. The samples treated with the antioxidants had stable levels of fat throughout the study. There were no significant differences between the B-29 formulations and the high ethoxyquin formulation.

The iodine value reflects the relative degree of unsaturation in a fat and is another indirect indicator of the level of oxidation of a fat. The higher the iodine value, the more stable and less oxidized is the sample. The iodine value of the untreated sample dropped significantly around week 11 and stayed low until the end of the study, indicating that the sample was oxidized. In contrast, the iodine values of the antioxidant treated samples remained high and constant at about 145 throughout the duration of the study. There were no significant differences between the B-29 treatments and the high level of ethoxyquin treatment, however.

This study revealed that both antioxidant formulations effectively prevented the oxidation of menhaden fishmeal stored at 50° C. for 24 weeks. Thus, the B-29 formulation comprising low levels of ethoxyquin was just as effective as a higher concentration of ethoxyquin at stabilizing fishmeal. The untreated fishmeal, in contrast, showed signs of oxidation and deterioration after about 11 weeks at 50° C. These data suggest that B-29 may be used at dosing rates that are similar to those of SANTOQUIN®.

What is claimed is:

1. A monophasic liquid composition comprising:
a. at least three antioxidants consisting of a first antioxidant that is a synthetic phenolic compound not having Formula (I), a second antioxidant selected from the group consisting of phenolic acid and derivatives, ascorbic acid and derivatives, tocopherols and derivatives, lecithin, bioflavonoid, and terpenoid; and a third antioxidant having Formula (I); 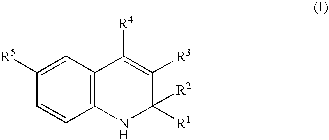
wherein:
R¹, R², R³ and R⁴ are independently selected from the group consisting of hydrogen and an alkyl group having from 1 to about 6 carbons; and
R⁵ is an alkoxy group having from 1 to about 12 carbons;
b. a polar solvent; and
c. a nonpolar solvent, wherein the two solvents form a substantially homogenous liquid.

2. The monophasic liquid composition of claim 1, wherein the synthetic phenolic compound is tertiary butyl hydroquinone; and the compound having Formula (I) is 6-ethoxy-1,2-dihydro-2,2,4-trimethylquinoline.

3. The monophasic liquid composition of claim 2, wherein the second antioxidant is n-propyl gallate.

4. The monophasic liquid composition of claim 2, wherein the second antioxidant is ascorbyl palmitate.

5. The monophasic liquid composition of claim 4, wherein the composition further comprises n-propyl gallate.

6. The monophasic liquid composition of claim 5, wherein the composition further comprises alpha-tocopherol.

7. The monophasic liquid composition of claim 4, wherein the composition further comprises lecithin.

8. The monophasic liquid composition of claim 3, wherein the composition further comprises lecithin.

9. The monophasic liquid composition of claim 8, wherein composition further comprises alpha-tocopherol and ascorbyl palmitate.

10. The monophasic liquid composition of claim 1, wherein the composition comprises at least 25% by weight of the antioxidants.

11. The monophasic liquid composition of claim 1, wherein the composition comprises less than about 5% by weight of the antioxidant having Formula (I).

12. The monophasic liquid composition of claim 1, wherein the composition comprises less than about 3% by weight of the antioxidant having Formula (I).

13. The monophasic liquid composition of claim 1, wherein the composition comprises less than about 1% by weight of the antioxidant having Formula (I).

14. The monophasic liquid composition of claim 2, wherein the polar solvent is selected from the group consisting of glycerol, isopropyl alcohol, propylene glycol, a sugar alcohol, and mixtures thereof; and the nonpolar solvent is selected from the group consisting of vegetable oil, monoglycerides, diglycerides, triglycerides, and mixtures thereof.

15. The monophasic liquid composition of claim 2, wherein the composition further comprises a co-solubilizer selected from the group consisting of didodecyl thiodipropionate, palmityl citrate, stearyl citrate, phospholipids, and combinations thereof.

16. The monophasic liquid composition of claim 1, wherein the composition comprises at least 25% by weight of the antioxidants; from about 10% to about 75% by weight of the polar solvent and non polar solvent, and wherein the composition comprises less than about 5% by weight of the antioxidant having Formula (I).

17. A monophasic liquid composition, the composition comprising 6-ethoxy-1,2-dihydro-2,2,4-trimethylquinoline, tertiary butyl hydroquinone, lecithin, n-propyl gallate, a polar solvent, and a non polar solvent, wherein the two solvents form a substantially homogenous liquid.

18. The monophasic liquid composition of claim 17, wherein the polar solvent is selected from the group consisting of glycerol, isopropyl alcohol, propylene glycol, a sugar alcohol, and mixtures thereof; and the nonpolar solvent is selected from the group consisting of vegetable oil, monoglycerides, diglycerides, triglycerides, and mixtures thereof.

19. The monophasic liquid composition of claim 17, wherein the polar solvent comprises glycerol; and the nonpolar solvent comprises corn oil and monoglycerides.

20. The monophasic liquid composition of claim 17, wherein the composition comprises from about 30% to about 40% by weight of antioxidants; from about 60% to about 70% by weight polar solvent and non polar solvent, and wherein the composition comprises less than about 5% by weight of 6-ethoxy-1,2-dihydro-2,2,4-trimethylquinoline.

21. The monophasic liquid composition of claim 17, wherein the composition comprises less than about 1% by weight of 6-ethoxy-1,2-dihydro-2,2,4-trimethylquinoline.

22. The monophasic liquid composition of claim 17, wherein the composition comprises about 5% by weight 6-ethoxy-1,2-dihydro-2,2,4-trimethylquinoline; about 10% by weight tertiary butyl hydroquinone; about 10% by weight n-propyl gallate; about 10% by weight lecithin; about 10% by weight glycerin; about 30% by weight monoglyceride; and about 23% by weight corn oil.

23. A method for inhibiting the oxidation of a lipid material, the method comprising contacting the lipid material with an effective amount of a monophasic liquid composition of claim 1.

24. The method of claim 23, wherein the lipid material is selected from the group consisting of fish oil, fish meal, vegetable oil, animal fat, yellow grease, and biodiesel.

25. The method of claim 24, wherein the fish oil is selected from the group consisting of menhaden oil, anchovy oil, albacore tuna oil, cod liver oil, herring oil, lake trout oil, mackerel oil, salmon oil, and sardine oil.

26. The method of claim 24, wherein the fish meal is selected from the group consisting of menhaden meal, anchovy meal, herring meal, pollack meal, salmon meal, tuna meal, and whitefish meal.

27. The method of claim 24, wherein the vegetable oil is selected from the group consisting of canola oil, corn oil, cottonseed oil, palm oil, peanut oil, safflower oil, soybean oil, and sunflower oil.

28. The method of claim 24, wherein the animal fat is selected from the group consisting of beef tallow, butter, pork lard, and poultry fat.

29. A composition, the composition comprising a product derived from a fish; and a monophasic liquid composition of claim 1.

30. The composition of claim 29, wherein the product derived from a fish is a liquid oil selected from the group consisting of menhaden oil, anchovy oil, albacore tuna oil, cod liver oil, herring oil, lake trout oil, mackerel oil, salmon oil, and sardine oil.

31. The composition of claim 29, wherein the product derived from a fish is fish meal selected from the group consisting of menhaden meal, anchovy meal, herring meal, pollack meal, salmon meal, tuna meal, and whitefish meal.

32. The composition of claim 29, wherein the concentration of the antioxidant having Formula (I) in the composition is less than about 100 ppm.

33. A process for manufacturing a monophasic liquid composition, the process comprising:
a) heating a vegetable oil to a temperature from about 40° C. to about 90° C. and then combining it with monoglyceride;
b) combining the vegetable oil mixture of (a) with 6-ethoxy-1,2-dihydro-2,2,4-trimethylquinoline while maintaining the temperature and agitating to form a 6-ethoxy-1,2-dihydro-2,2,4-trimethylquinoline-oil matrix;
c) sequentially combining the matrix of (b) first with tertiary butyl hydroquinone followed by lecithin while maintaining the temperature and agitating, wherein lecithin is dissolved in the oil matrix;
d) dissolving propyl gallate in a solvent selected from the group consisting of glycerin and propylene glycol;
e) combining the product of (d) with the product of (c) while maintaining the agitation and temperature for a time sufficient such that a substantially homogeneous liquid is produced.
